(19) United States
(12) Patent Application Publication
(10) Pub. No.: US 2002/0188896 A1
(43) Pub. Date: Dec. 12, 2002

(54) System and method for generating multi-lingual reports

(76) Inventors: Sheila B. Filteau, Methuen, MA (US); Christina E. Banta, Andover, MA (US)

Correspondence Address: PHILIPS ELECTRONICS NORTH AMERICAN, 580 WHITE PLAINS ROAD, TARRYTOWN, NY, 10591, US

(21) Appl. No.: 09/876,649

(22) Filed: Jun. 7, 2001

(51) Int. Cl. H02H 3/05; H04B 1/74

(52) U.S. Cl. 714/57

(57) ABSTRACT

The present disclosure relates to systems and methods for medical diagnostic reporting. The method generally includes, identifying diagnostic findings, translating the identified findings into a reporting language, inserting the translated findings into a language encoded database, and using the language encoded database in a physician directed iterative process to identify diagnostic findings responsive to observed images. The method may be implemented by a system with a data storage device, an execution memory device, a report output device, and a processor.

### FIELD OF THE INVENTION

The present disclosure relates to diagnostic reporting. More particularly, a system and method for enhanced diagnostic medical reporting are disclosed.

### BACKGROUND OF THE INVENTION

Many clinical diagnostic imaging studies are recorded as a particular test or tests are performed on a patient of interest by a technician. Generally, a trained technician performs a number of tasks in order to record information that is required to diagnose one or more medical conditions using an imaging acquisition system. The technician collects, and may even edit, portions of the recorded information or study in order to identify reference points in the patient's anatomy. The images may then be recorded on videotape, fixed disk drives, as well as, other data storage devices for later analysis and reporting by a physician.

Since a large amount of detailed information must be viewed, evaluated, and discussed in these reports, computerized medical report generation systems have been developed. Some of the report generation systems are generic to medical reports, while others are specific to the imaging study (e.g., echocardiographic reports) performed by the technician.

Traditional report generation systems use a primary language for menus, graphical user interfaces (GUIs), and report results. Often, this primary language is selected based upon the local language of the typical-reporting physician practicing within a particular geographic region. For example, in the United States, report generation systems provide text-based menus and graphical user interfaces written in the English language. In France, report generation systems use the French language. Consequently, the reports generated by the English-based systems are prepared in English and reports generated by the French-based systems are written in French.

Throughout the world, however, it is common to encounter multi-lingual physicians. This is especially true in countries that promote multiple national languages. Canada, for example, has two national languages, English and French. It is also fairly common for multi-lingual physicians to receive medical training in foreign countries.

### SUMMARY OF THE INVENTION

From the above, it can be appreciated that it would be desirable to provide a system for generating reports that enables a multi-lingual reporting physician to automatically generate diagnostic reports in a language other than the language used in the various menus and GUIs of the application software. It will be further appreciated that it would be desirable to have a method that provides an automated report generation solution that supports not only multiple reporting languages, but the capability to report various quantitative measures using “personalized” language choices of the reporting physician.

Briefly described, in architecture, a multi-lingual report generation system can be implemented with a data storage device, a data storage editor, a user interface, a decision logic engine, a renderer, and a report output device.

A method for generating a set of related diagnostic findings in a reporting language generally includes the following steps: retrieving a set of diagnostic findings having an associated text field written in the same language as an application interface; translating the set of diagnostic findings into a reporting language that is different from the language used by the application interface; and storing the translated diagnostic findings.

The present disclosure also presents a method for configuring a customized reporting physician profile. This second method generally includes the following steps: identifying the reporting physician; acquiring a default physician profile wherein diagnostic finding descriptions are written in a reporting language that is the same or different from the language used by the application interface; retrieving a study type; presenting at least one diagnostic finding set responsive to the reporting language and the study type via a graphical user interface; and permitting the reporting physician to add self-generated diagnostic finding codes to the at least one diagnostic finding set.

In addition, the present disclosure presents a method for generating a diagnostic report in a physician selectable reporting language. This third method, generally includes: acquiring a patient study; identifying the study type; retrieving a reporting profile associated with the reporting physician; generating a graphical user interface; observing the patient study; and generating the report by selecting appropriate diagnostic finding codes responsive to the observed images.

Other features and advantages of the system and method for enhanced diagnostic medical reporting will become apparent to one skilled in the art upon examination of the following drawings and detailed description. It is intended that all such additional features and advantages be included herein as protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram of an exemplary post-acquisition diagnostic environment suited to the improved medical report generator.

FIG. 2 is a functional block diagram of the improved medical report generator of FIG. 1.

FIG. 3 is a table illustrating information that may be associated with records within the reporting language database of FIG. 2.

FIG. 4 is a flow chart illustrating a method for generating a set of related diagnostic findings in a reporting language that may be used to configure the improved medical report generator of FIG. 2.

FIG. 5 is a flow chart illustrating a method for configuring a customized reporting physician profile that may be used by the improved medical report generator of FIG. 2.

FIG. 6 is a flow chart illustrating a method for generating a diagnostic report in a physician selectable reporting language that may be implemented by the improved medical report generator of FIG. 2.

FIG. 7A is a schematic diagram of an exemplary GUI suited for editing diagnostic findings and diagnostic finding sets that may be stored in a database associated with the medical report generator of FIG. 2.

FIG. 7B is a schematic diagram of an exemplary GUI suited for configuring a user reporting profile that may be used by the medical report generator of FIG. 2 to generate a diagnostic report.

FIG. 8A is a schematic diagram illustrating the left portion of a GUI suited to display an exemplary report that may be generated by the medical report generator of FIG. 2.

FIG. 8B is a schematic diagram illustrating the right portion of the GUI introduced in FIG. 8A.

FIG. 8C is a schematic diagram illustrating a diagnostic finding code table that overlays the schematic of FIG. 8B.

FIG. 8D is a schematic diagram illustrating an alternative data entry mode that uses a pop-up window that overlays the schematic of FIG. 8B.

### DETAILED DESCRIPTION

The present disclosure generally relates to an automated reporting system. According to one aspect of the improved medical reporting system, a plurality of default findings are translated and added to a diagnostic finding database for selection and subsequent insertion into a pre-formatted report profile. In another aspect of the medical reporting system, a database editor is provided to permit physicians or other operators of the system to modify the text of a default (i.e., previously supplied) diagnostic finding and store the modified diagnostic finding as a new diagnostic finding in a reporting language, and optionally group a plurality of diagnostic findings generated in the same reporting language into user, study type, and/or site preferred reporting profiles.

In either case, the improved medical reporting system is preferably used together with one or more systems configured to display diagnostic images from an ultrasound imaging acquisition and image storage system or other medical diagnostic imaging devices. It should be appreciated that the improved medical reporting system may be integrated with a number of various imaging devices to permit post acquisition analysis and automated report generation by diagnosing physicians. Some exemplary clinical applications may include imaging of the heart in general, coronary artery imaging, coronary flow reserve assessment, blood perfusion imaging, and tumor detection by imaging blood supply to various organs throughout the body.

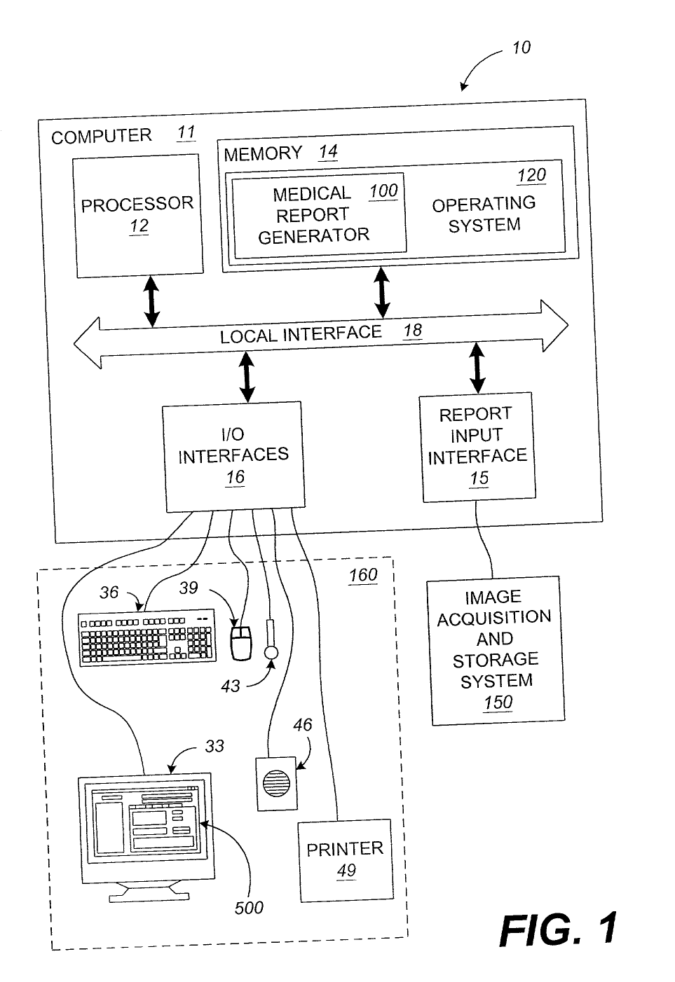

Referring now in more detail to the drawings, in which like numerals indicate corresponding parts throughout the several views, attention is now directed to FIG. 1, which illustrates the general post-acquisition diagnostic environment where an enhanced medical report generator may practice the various methods enclosed herein to generate multi-lingual diagnostic reports. In this regard, the medical report generator can be implemented in software, firmware, hardware, or a combination thereof. In the currently contemplated best mode, the medical report generator is implemented in software, as an executable program, and is executed by a special or general purpose digital computer, such as a personal computer (PC; IBM-compatible, Apple-compatible, or otherwise), workstation, minicomputer, or mainframe computer. An example of a post-acquisition diagnostic environment is shown in FIG. 1. The post-acquisition diagnostic environment is generally denoted by reference numeral 10 and may comprise a general purpose computer 11, a host of associated input and/or output (I/O) peripherals 160, as well as, an image acquisition and storage system 150.

Generally, in terms of hardware architecture, as shown in FIG. 1, the computer 11 includes a processor 12, memory 14, and one or more I/O interfaces 16 (or peripheral interfaces) that are communicatively coupled via a local interface 18. The local interface 18 can be, for example but not limited to, one or more buses or other wired or wireless connections, as is known in the art. The local interface 18 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 12 is a hardware device for executing software that can be stored in memory 14. The processor 12 can be any custom-made or commercially-available processor, a central processing unit (CPU) or an auxiliary processor among several processors associated with the computer 11, and a semiconductor based microprocessor (in the form of a microchip) or a macro-processor. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, or a 68xxx series microprocessor from Motorola Corporation.

The memory 14 can include any one or combination of volatile memory elements (e.g., random access memory (RAM, such as dynamic RAM or DRAM, static RAM or SRAM, etc.)) and nonvolatile memory elements (e.g., read only memory (ROM), hard drive, tape drive, compact disc (CD-ROM), etc.). Moreover, the memory 14 may incorporate electronic, magnetic, optical, and/or other types of storage media. Note that the memory 14 can have a distributed architecture, where various components are situated remote from one another, but can be accessed by the processor 12.

The software in memory 14 may include one or more separate programs, each of which comprises an ordered listing of executable instructions for implementing logical functions. In the example of FIG. 1, the software in the memory 14 includes the medical report generator 100 and a suitable operating system 120. A non-exhaustive list of examples of suitable commercially available operating systems 120 is as follows: a Windows operating system from Microsoft Corporation, a Netware operating system available from Novell, Inc., or a UNIX operating system, which is available for purchase from many vendors, such as Hewlett-Packard Company and Sun Microsystems, Inc. The operating system 120 essentially controls the execution of other computer programs, such as the medical report generator 100, and provides scheduling, input-output control, file and data management, memory management, communication control and related services.

The medical report generator 100 is a source program, executable program (object code), script, or any other entity comprising a set of instructions to be performed. When in the form of a source program, the program needs to be translated via a compiler, assembler, interpreter, or the like, which may or may not be included within the memory 14, so as to operate properly in connection with the operating system 120. Furthermore, the medical report generator 100 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada. In the currently contemplated best mode of practicing the invention, the medical report generator 100 is written in C++.

The I/O devices 160 may include input devices, for example but not limited to, a keyboard 36, a mouse 39, a microphone 43, etc. Furthermore, the I/O devices 160 may also include output devices, for example but not limited to, a display 33, a printer 49, an external speaker 46, etc. Finally, the I/O devices 160 may further include devices that communicate both inputs and outputs, for instance but not limited to, a modulator/demodulator (modem; for accessing another device, system, or network), a radio frequency (RF) or other transceiver, a telephonic interface, a bridge, a router, etc. For simplicity of illustration, these aforementioned two-way communication devices are not illustrated.

If the computer 11 is a PC, workstation, or the like, the software in the memory 14 may further include a basic input output system (BIOS) (also omitted for simplicity of illustration). The BIOS is a set of essential software routines that initialize and test hardware at startup, start the operating system 120, and support the transfer of data among the hardware devices. The BIOS is stored in a ROM so that the BIOS can be executed when the computer 11 is activated.

When the computer 11 is in operation, the processor 12 is configured to execute software stored within the memory 14, to communicate data to and from the memory 14, and to generally control operations of the computer 11 pursuant to the software. The medical report generator 100 and the operating system 120, in whole or in part, but typically the latter, are read by the processor 12, perhaps buffered within the processor 12, and then executed.

When the medical report generator 100 is implemented in software, as is shown in FIG. 1, it should be noted that the medical report generator 100 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The medical report generator 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CD-ROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

As illustrated in FIG. 1, the computer 11 may be configured with a report input interface 15 suited to receive data from the image acquisition and storage system 150. It should be appreciated that the report input interface 15 may take the form of a network connection with suitable bandwidth to receive a real time video stream provided by an ultrasound imaging system (not shown). Alternatively, the report-input interface 15 may take the form of a storage device interface such as a tape drive interface or a real time image interface. Whatever the nature of the image acquisition and storage system 150 (real time or post acquisition replay), the computer 11 works together with the display 33 and the interfaces 15, 16 to reproduce a plurality of diagnostic images that may be viewed, analyzed and reported on by a diagnosing physician.

Medical Report Generator Architecture and Operation

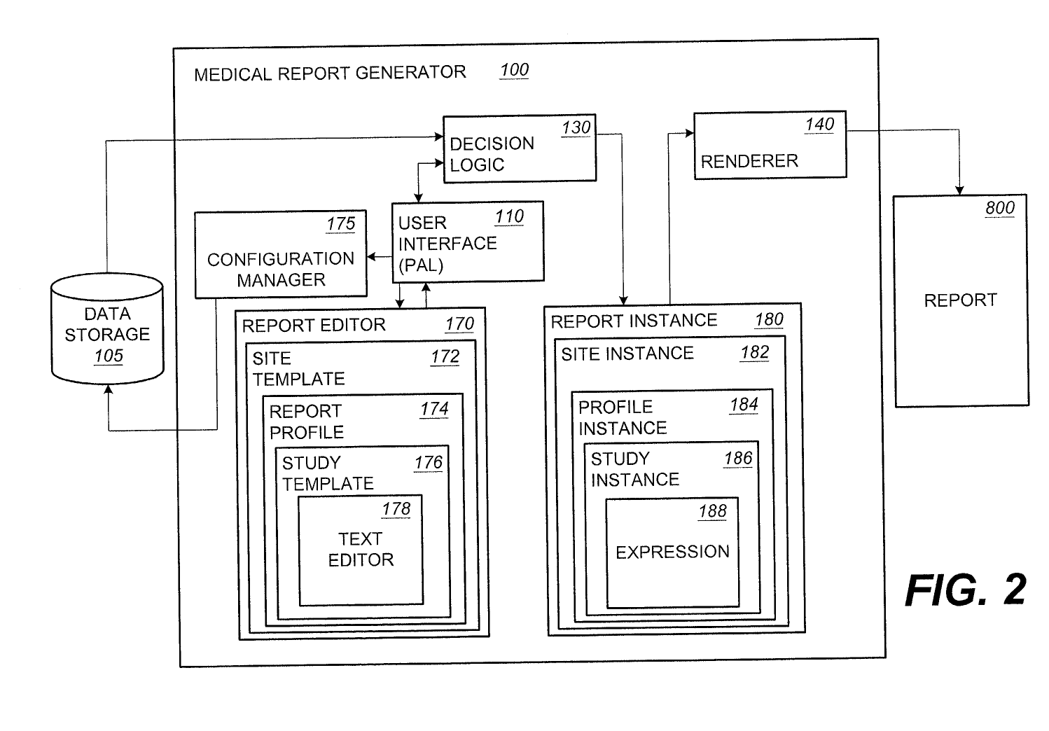

Referring now to FIG. 2, the medical report generator 100 consists of a data storage device 105, a user interface 110, a decision logic engine 130, a report editor 170, a renderer 140, and a configuration manager 175. As illustrated in the block diagram of FIG. 2, the user interface 110 is in communication with the report editor 170, the decision-logic engine 130, and the configuration manager 175. As further illustrated in FIG. 2, the decision logic engine 130 is in communication with the data storage device 105 and the user interface 110 and is configured to generate a report instance 180 based on inputs from the data storage device 105 and the user interface 110. In turn, the renderer 140 receives and converts information from the report instance 180 and creates the medical diagnostic report 800.

The user interface 110 consists of a plurality of data entry windows or frames presented in a primary application language (PAL). The PAL often takes the form of the local language and represents a default reporting language that may be used within the medical report generator 100. Preferably, the user interface 110 is in the form of a plurality of GUIs presented under a standard human machine interface easily recognizable and operable by the reporting physicians. For example, the user interface 110 may take the form of a plurality of application windows each configured with a menu bar and a command bar containing one or more file command push-buttons, and one or more format command push-buttons.

The data storage device 105 contains a plurality of supplied diagnostic findings. Each diagnostic finding is associated with a text field written in the same language that was used to create the user interface 110. The data storage device 105 may also contain a plurality of records identifying one or more local reporting templates or profiles that may be selected by a reporting physician in order to tailor the format of her report. The decision logic 130 receives a site report definition from the data storage device 105 and user selections from the user interface 110. The site report definition may be imported by the report editor 170 via the user interface 110 and the decision logic engine 130 to provide site-specific report-formatting rules in the form of a site template 172 to be applied in all diagnostic reports generated with the medical report generator 100. Alternatively, the site template 172 may be configured as a default template for all diagnostic reports 800 generated with the medical report generator 100.

The report editor 170 may be associated with at least one site template 172, which in turn is associated with at least one report profile 174. Each report profile 174 may in turn be associated with one or more study templates 176. As also illustrated in the block diagram illustrated in FIG. 2, the report editor 170 may be provided with a text editor 178.

The data storage device 105 contains a plurality of records identifying one or more of these site templates 172 or user specific reporting templates or profiles 174 that may be selected by a reporting physician to tailor the format of her report. This custom template or report profile 174 is preferably imported by the report editor 170 via the user interface 110 to provide user (i.e., reporter) specific report formatting rules that are applied in diagnostic reports prepared by the individual user that generated the template or report profile 174.

The data storage device 105 may also contain a plurality of records identifying one or more reporting templates for specific types of studies, or profiles that may be selected by a reporting physician to tailor the format of her report. This customized study template 176 may be imported by the report editor 170 via the user interface 110 to provide study-specific report-formatting rules to be applied in diagnostic reports related to a particular study type created by the medical report generator 100.

As also illustrated in FIG. 2, a configuration manager 175 in communication with the user interface 110 and the data storage device 105 may be added to the medical report generator 100 to permit site, reporter, and study reporting flexibility. The configuration manager 175 allows a site administrator, a reporting physician, and/or another authorized operator of the medical report generator 100 that desires to add a common diagnostic finding to easily accomplish the task.

The new diagnostic finding and its associated text can be provided in the default reporting language (PAL) or the operator may elect to add a diagnostic finding in a secondary reporting language (SRL) different from the language used by the user interface 110 (i.e., the PAL). Preferably, the operator associates the new diagnostic finding with an appropriate study type so that the diagnostic finding will be available in a displayed list or set of diagnostic findings appropriate to include in a diagnostic report 800 of the anatomy presented in the images being analyzed.

In addition, the configuration manager 175 is configured to permit authorized operators to edit the text field associated with a particular finding. The text of a particular finding cannot be changed after it has been used in a report. The reporting physician is free to add a new code with an associated text field via the configuration manager 175. In addition, the reporting physician can remove undesired finding codes from her reporting profile. This functionality permits a multi-lingual reporting physician the flexibility to modify quantitative language in his or her preferred reporting language.

The medical report generator 100 may be configured to permit access only by reporting physicians authorized by the editing user. Alternatively, site wide rules may be applied such that diagnostic findings edited by one or more French-language reporting physicians may be made available to all reporting physicians that select French as their reporting language. It is significant to note that a default set of diagnostic findings with associated text written in the primary application language (PAL) is available to all reporting physicians.

As also illustrated in FIG. 2, the report editor 170 is constrained by report generation rules and standards codified in the site template 172, the operator's report profile 174, and the study template 176. For example, the site template 172 may include identifying information regarding the organization such as contact information. The site template 172 may also include a standard format for entering patient identifying information. In contrast, an operator's personalized report profile 174 may include identifying information regarding the reporting physician as well as standard formatting commands for presenting the information. In addition, a report profile 174 may include a list of studies that the reporter is qualified to analyze, as well as, a preferred set of diagnostic findings that include sentences that the reporter approves of for inclusion in the final diagnostic report 800. A study template, on the other hand, may include information identifying the source of the images being analyzed, the type of report (i.e., study) being presented, as well as, a set of appropriate selected diagnostic findings previously approved for inclusion in a diagnostic report 800 of that particular type.

As further illustrated in FIG. 2, the report editor 170 may be configured to provide a text editor 178 operable with the user interface 110 to permit an operator of the medical report generator 100 to complete any necessary modifications either to the previously supplied or site modified diagnostic findings. It will be appreciated that the medical report generator 100 may also be configured with one or more editors configured to permit user modification of the various reporting templates 172, 176 or profiles 174 (when the operator is so authorized). The text editor 178 preferably contains functionality suited to permit an operator of the medical report generator 100 to perform commonly practiced text editing tasks. For example, the text editor 178 may be configured to permit “pasting” of text “copied” from text generated within the text editor 178 itself or text generated in an external word processing application. In addition, the text editor 178 may be configured with a spell check capability operable in the reporting language selected by the reporting physician. Furthermore, it is contemplated that the text editor 178 is configured with a knowledge base that includes medical terminology associated with the anatomy of interest in the present study.

Various other report formats may also be provided. For example, the site template 172 can be associated with more than one report profile 174. Each report profile 174 in turn, can use more than one study template 176, and each of these can be selectively edited to provide site, reporter, and study customizable reports.

As further illustrated in FIG. 2, the decision logic 130 works together with the user interface 110 and the report editor 170 to generate a report instance 180 that contains a site instance 182, a profile instance 184, a study instance 186, and an expression 188. Each of the aforementioned instances 182, 184, and 186 represents the integration of site, profile, and study specific data respectively in accordance with the rules provided in the associated templates 172, 176 and/or profiles 174 selected by the operator. The report instance 180 also includes an expression 188 representative of the cumulative information selected and/or edited by the operator in generating a particular medical diagnostic report 800.

The report instance 180, as shown in FIG. 2, is forwarded to the renderer 140, which is configured to generate an appropriate representation of the diagnostic report 800. Preferably, the renderer 140 is configured to selectively interface with a plurality of I/O devices. For example, in a preferred embodiment, the renderer 140 is configured to interface with a web browser application to display a GUI 500 (FIG. 1) that may be used by an operator to generate the report 800 in real time (i.e., as it is being generated) on the display 33 (FIG. 1) or any other display device in communication with the computer 11 (FIG. 1).

It should be appreciated that once the report 800 is available in buffers associated with a web browser or other suitable application integrated with various reporting devices, the report can be processed and is no longer dependent upon the medical report generator 100. For example, if the report 800 is present within an integrated web browser application, the report 800 may be stored, faxed, displayed, electronically mailed, and or printed by commands generated within the web browser. Once the report 800 has been stored on a networked device, the report 800 will be available via any of the aforementioned delivery methods to operators granted appropriate file access.

The medical report generator 100 is preferably programmed to provide a standard computer interface commonly used with popular word processing programs. Included therein are several functional items that are defined below:

Context-Sensitive Menu—A menu that highlights options as available or unavailable depending upon the context in which the menu is called.

Drop Down Menu—Drops down from menu bar and remains active until closed or an available menu option is selected.

Menu Bar—Bar across top of screen that contains one or more labels which activate an associated drop down menu.

Pull Down Menu—A sub-menu that is typically activated by moving a pointing device over a drop down menu option.

Pop-up Menu—Menu that is activated upon selection of a feature push-button.

Scroll Bar—Bar at side or bottom of screen that allows user to scroll left-right and/or up and down through a large window.

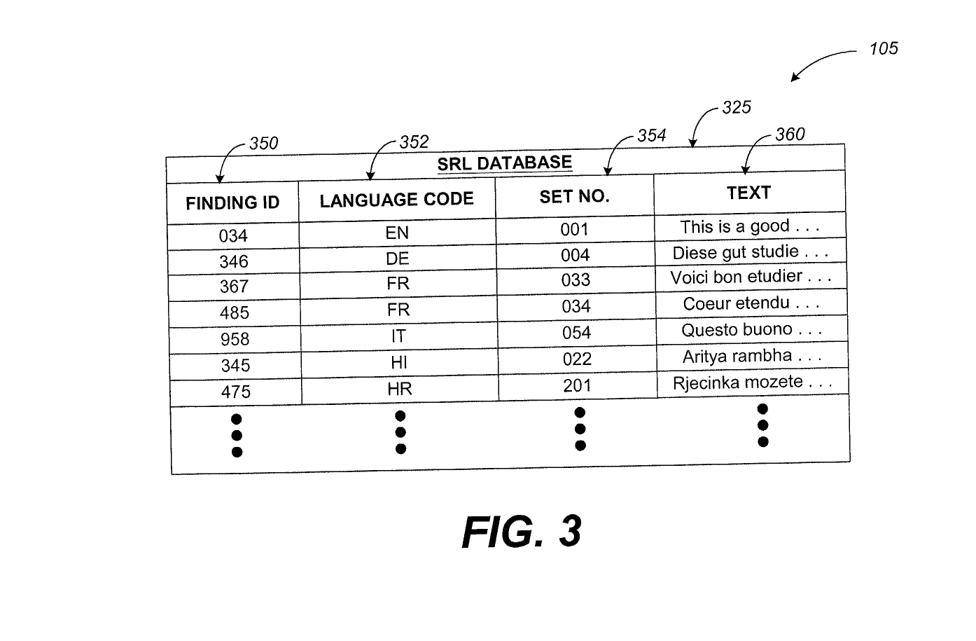

Reference is now directed to FIG. 3, which presents a table illustrating information that may be associated with records within a secondary reporting language (SRL) database 325 which may be contained within the data storage device 105 of FIG. 2. In this regard, the SRL database 325 may comprise a plurality of records wherein each record includes a diagnostic finding identifier or finding ID 350, a language code 352, a diagnostic finding set identifier or set no. 354, and a text field 360. It will be appreciated that the SRL database 325 is presented in the form of a relational database with a plurality of records each containing a plurality of fields. Alternatively, the SRL database 325 may be structured as an object oriented database as is known in the art.

Each record instance of the finding ID 350, the language code 352, and the set no. 354 may be stored as an alphanumeric string having a varying length dependent upon specific design choices. Preferably, the language code is selected from the International Organization for Standardization (a.k.a. ISO-ISO is an acronym for the Greek work meaning equal) code 639-2 1998, which includes standard codes for identifying languages. However, the medical report generator 100 is not limited to using standard language codes as defined in the ISO 639-2 standard.

As is also illustrated in the table of FIG. 3, each record instance of the finding ID 350, the language code 352, and the set no. 354 may be associated with a report text field 360. This report text field 360 contains the language that will be retrieved and presented in the medical diagnostic report 800 when a reporting physician selects a specific diagnostic finding ID 350. By way of example, when a reporting physician selectively desires to generate a diagnostic report 800 in the French language, the medical report generator 100 may be configured to present a GUI that offers a diagnostic finding ID “367” in association with a diagnostic finding set “033.” As shown in FIG. 3, the text entered in the diagnostic report 800 will reflect the text in the associated report text field 360 or “Voici bon etudier . . . ”

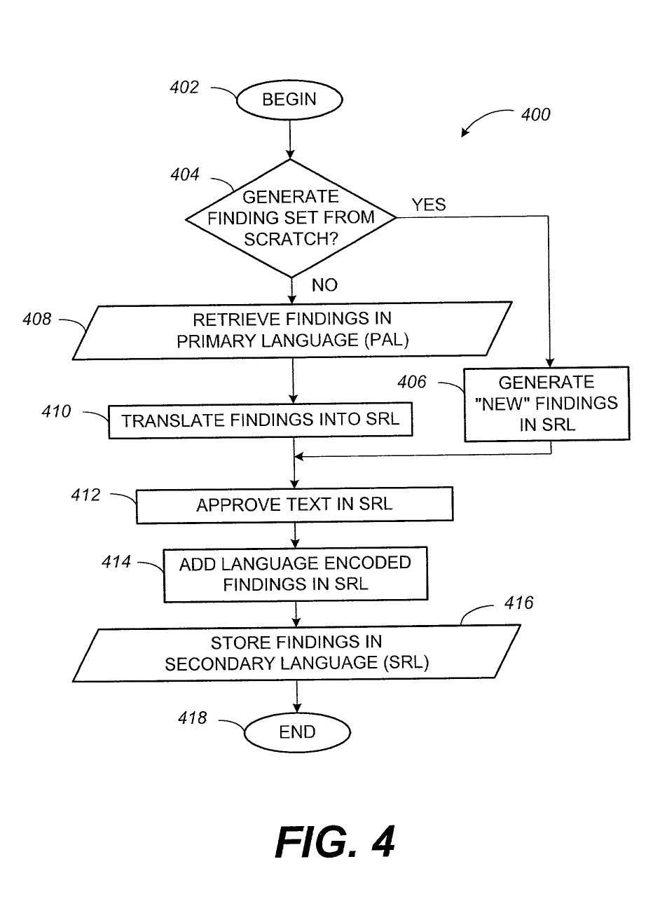

Reference is now directed to FIG. 4, which presents a flow chart illustrating a method for generating a set of related diagnostic findings in a reporting language that may be used to configure the improved medical report generator 100 of FIG. 2. In this regard, the method for generating a set of related diagnostic findings in a reporting language 400 may begin with step 402, labeled “BEGIN.” First, the method for generating a set of related diagnostic findings in a reporting language 400 may be configured to perform a query to determine if it is desired to create a “new” diagnostic finding set without using a previously generated finding set authored in the primary application language or some other language as indicated in step 404. If the response to the query of step 404 is affirmative, i.e., the author desires to create a “new” set of diagnostic findings in a secondary reporting language, the method for generating a set of related diagnostic findings in a reporting language 400 branches as illustrated by the “Yes” flow control arrow to perform step 406, where one or more new diagnostic findings are created and stored in the reporting language of choice. Next, the method for generating a set of related diagnostic findings in a reporting language 400 is configured to perform step 412 as shown by the flow control arrow exiting step 406.

Otherwise, the method for generating a set of related diagnostic findings in a reporting language 400 retrieves a set of previously created diagnostic findings written in the primary application language or PAL as indicated in step 408. The diagnostic findings are then presented to qualified interpreters who translate the text phrases associated with the diagnostic findings into a secondary reporting language as shown in step 410. Next, in step 412, the translated findings may be formally approved by one or more multi-lingual physicians or otherwise qualified individuals.

Once the set of diagnostic findings associated with text generated in the secondary reporting language or SRL have been approved, each of the diagnostic findings may be associated with a language code as indicated in step 414. The set of language encoded diagnostic findings are then stored as illustrated in step 416. The method for generating a set of related diagnostic findings in a reporting language 400 having accomplished its primary task may then be terminated as indicated in step 418, labeled, “END.”

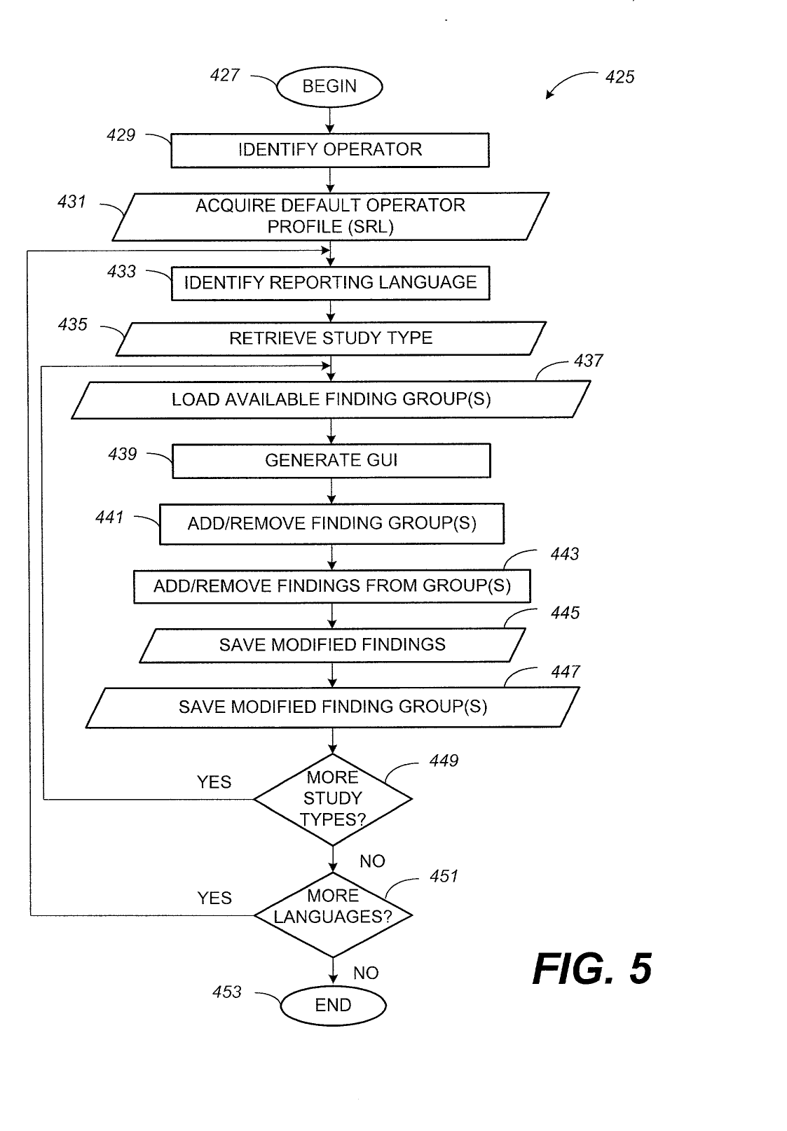

Reference is now directed to FIG. 5, which presents a flow chart illustrating a method for configuring a customized reporting physician profile that may be used by the improved medical report generator of FIG. 2. As shown in FIG. 5, the method for configuring a customized reporting physician profile 425 may begin with step 427, labeled “BEGIN.” First, the method for configuring a customized reporting physician profile 425 may be configured to identify the present operator of the configuration manager application as indicated in step 429. The method for configuring a customized reporting physician profile 425 may then acquire a default operator profile as shown in step 431. Alternatively, the method for configuring a customized reporting physician profile 425 may retrieve an operator specific profile. The operator specific reporting profile may be associated with one or more diagnostic finding sets each containing text fields generated in a secondary reporting language. Next, the operator may be prompted to enter a desired reporting language as illustrated in step 433. The method for configuring a customized reporting physician profile 425 may then retrieve a study type as illustrated in step 435.

The method for configuring a customized reporting physician profile 425, having identified a desired reporting language, a study type, and an operator profile may then be configured to load one or more diagnostic finding groups or sets responsive to the operator profile and the study type as indicated in step 437. Next, a configuration management GUI may be generated and presented to the operator as shown in step 439.

At this point, as shown in step 441, the operator may be presented with a configuration management GUI that may permit the operator to add/remove finding groups from the operator profile. As is illustrated in step 443, the method for configuring a customized reporting physician profile 425 is configured to add/remove specific diagnostic findings with modified text statements describing the associated diagnostic finding to the presently active diagnostic finding set or group. Next, in step 445, the method for configuring a customized reporting physician profile 425 is configured to save modified findings. In step 447, the method for configuring a customized reporting physician profile 425 is configured to save any modified finding groups.

Note that the operator may remain in the edit configuration modes associated with method steps 441 and 443 as long as necessary to complete the various editing tasks desired. Once the operator is satisfied with the various reporting profiles, the information may be saved as indicated in steps 445 and 447.

Next, the operator may be prompted as to whether there are any additional study types that have user profiles to be modified as illustrated in the query of step 449. It will be appreciated that alternatively the operator may be presented with an optional study type selection interface to identify a study type of interest to the configuration management GUI. When the response to the query of step 449 is affirmative, the method for configuring a customized reporting physician profile 425 may be configured to repeat steps 437 through 449 as indicated by the flow control arrow in the “YES” branch of the flowchart.

Otherwise, the method for configuring a customized reporting physician profile 425, having accomplished the editing task in a first reporting language, may be configured to query the operator whether additional reporting languages are to be configured as illustrated in the query of step 451. When the response to the query of step 451 is affirmative, the method for configuring a customized reporting physician profile 425 may be configured to repeat steps 433 through 451 as indicated by the flow control arrow in the “YES” branch of the flowchart. The method for configuring a customized reporting physician profile 425, having completed the various configuring tasks, may then be terminated as indicated in step 453, labeled, “END.”

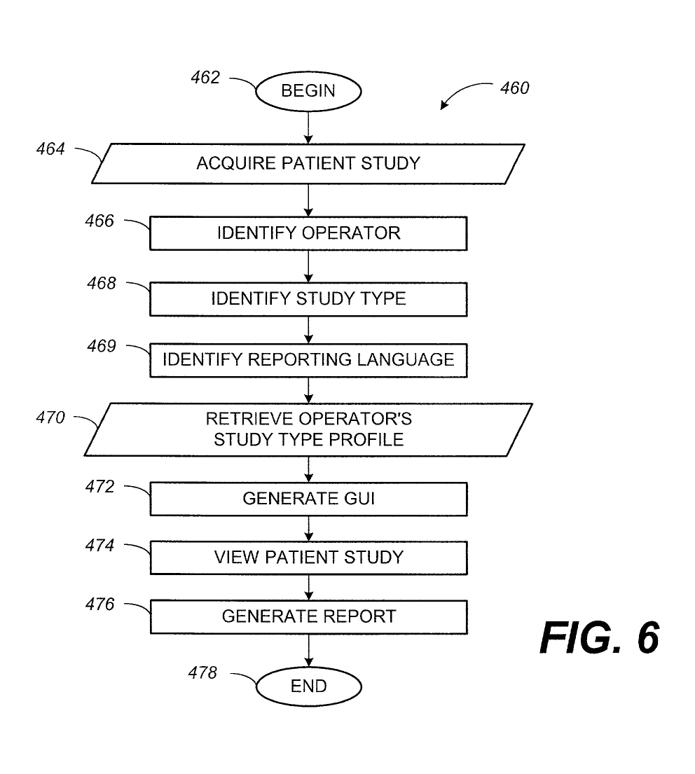

FIG. 6 presents a flow chart illustrating a method for generating a diagnostic report 800 in a physician selectable reporting language that may be implemented by the improved medical report generator of FIG. 2. In this regard, the method for generating a diagnostic report 460 may begin with step 462, labeled “BEGIN.” First, the method for generating a diagnostic report 460 may be configured to acquire a patient study as illustrated in step 464. Next, the method for generating a diagnostic report 460 may be configured to identify the present operator, the study type, and the present reporting language in steps 466, 468, and 469, respectively. The method for generating a diagnostic report 460 having identified the study type and the operator of the medical report generator 100 may be configured to retrieve the study profile associated with the present operator as illustrated in step 470. The study profile associated with the present operator may be associated with one or more diagnostic finding sets each containing text fields generated in a secondary reporting language.

Next, the method for generating a diagnostic report 460 may be configured to generate an interactive GUI as shown in step 472. With the medical report generator 100 initialized, the operator may then proceed to view and analyze the patient study as indicated in step 474. Once the operator has reached a diagnostic conclusion related to each of the various portions of the reporting template related to the present study, the operator may use the medical report generator 100 to create the diagnostic report 800 as indicated in step 476. Once the operator is satisfied that the report is complete, any of a number of operator initiated command inputs may be entered to terminate the method for generating a diagnostic report 460 as indicated in step 478, labeled, “END.”

Any process descriptions or blocks in the flowcharts of FIGS. 4-6 should be understood as representing modules, segments, or portions of code which include one or more executable instructions for implementing specific logical functions or steps in the configuration management GUI or the medical report generator 100. Alternate implementations are included within the scope of the preferred embodiment of the medical report generator 100 in which functions may be executed out of order from that shown or discussed, including substantially concurrently or in reverse order, and/or manually, depending on the functionality involved, as would be understood by those reasonably skilled in the art of the present invention.

Configuration Manager Interfaces

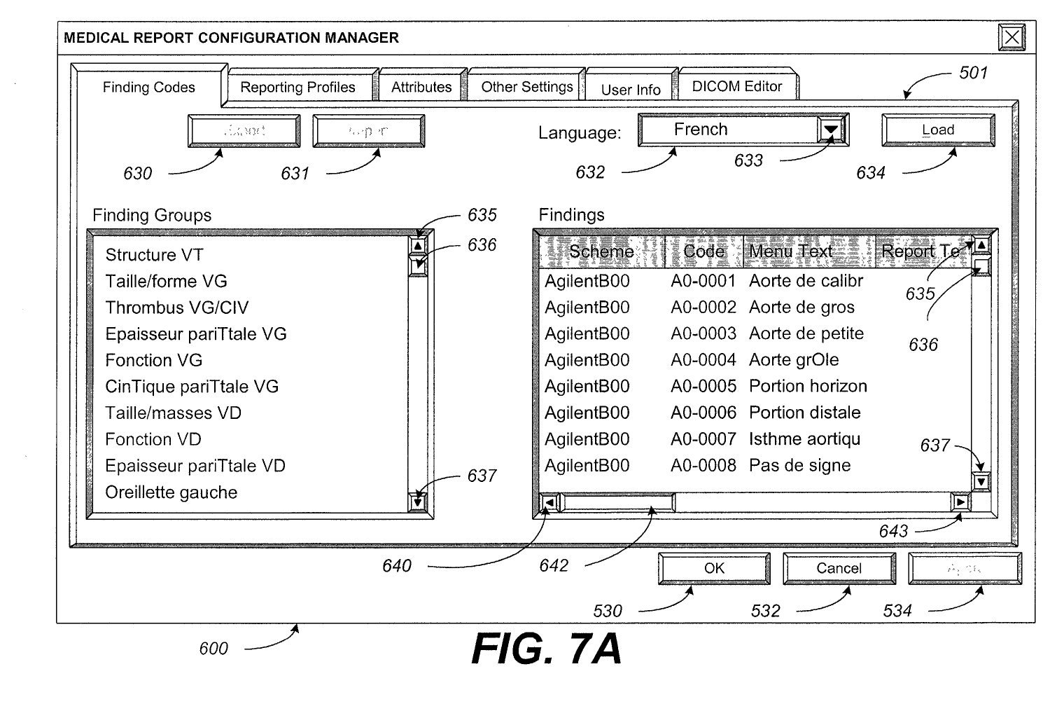

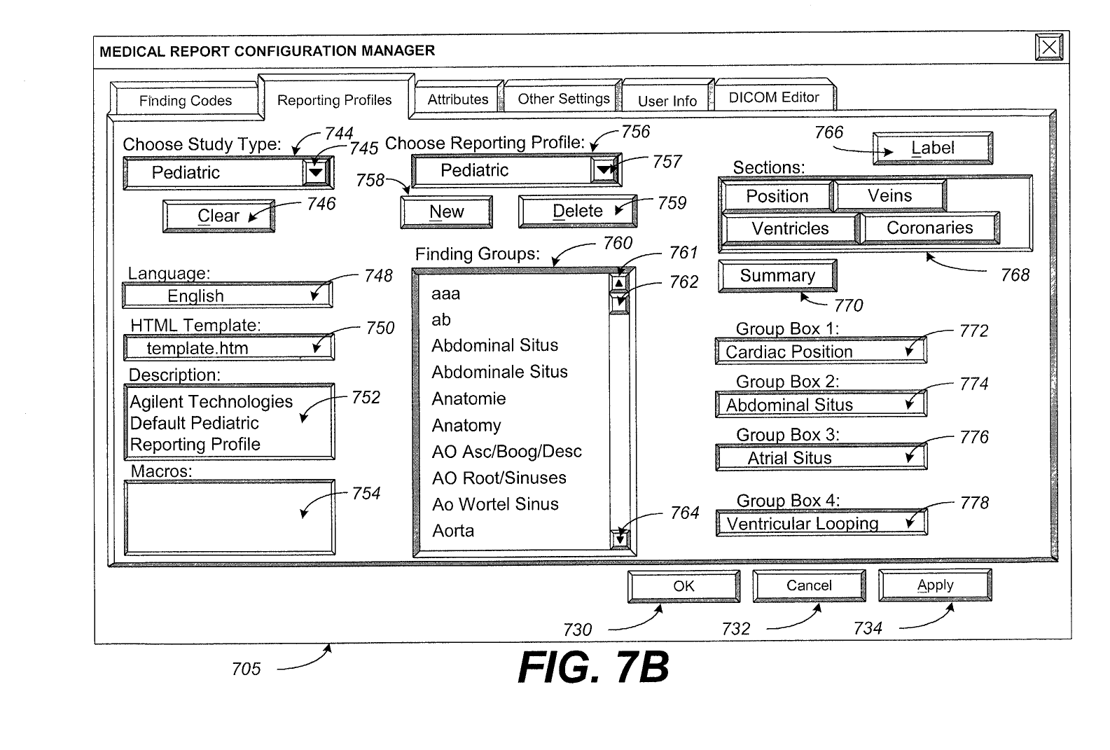

A preferred configuration manager GUI is presented in FIG. 7A. More specifically, FIG. 7A illustrates a schematic diagram of a preferred GUI suited for selecting a SRL and one or more diagnostic finding groups or sets that may be included in a final diagnostic report 800. FIG. 7A generally illustrates a GUI denoted by reference numeral 600 that may be provided by the configuration manager 175 to control operator access to various SRLs and associated diagnostic finding sets that may be stored within a SRL database 325 (FIG. 3) within the data storage device 105 (FIG. 2). As previously described, the various SRLs available in the data storage device 105 are supplied in the form of pre-authorized and/or operator-added text phrases descriptive of a particular diagnostic finding. Each diagnostic finding stored in the data storage device 105 is encoded with information indicative of the language used by the reporting physician in the text that describes the particular diagnostic finding.

As illustrated, the GUI 600 may present a series of layered pages each contextually modified for a particular purpose. In this regard, FIG. 7A presents an exemplary interface that may be presented to an operator upon selecting the “Finding Codes” interface page. The interface page 501 may contain “Export” and “Import” selection buttons 630, 631, a SRL data entry field 632 having a pre-configured scrollable menu that may be made operable by using a pointing device to select a down arrow 633. The interface page 501 may also contain a “Load” push-button 634 operable to release a previously selected diagnostic finding set and to retrieve a plurality of diagnostic finding sets suited for reporting in the operators selected reporting language.

As also illustrated in the interface of FIG. 7A, the medical report generator 100 may be configured to present a “Finding Groups” display window and a “Findings” display window as shown. It will be appreciated that each of the display windows may be configured with one or more push-buttons and slides to enable an operator to scroll through the data presented. For example, the “Finding Groups” display window may be supplied with an up arrow push-button 635, a down arrow push-button 637, and an up down scroll slide button 636. Similarly, the “Findings” display window may be supplied with an up arrow push-button 635, a down arrow push-button 637, and an up down scroll slide button 636.

In those cases where the data to be displayed in a particular display window exceeds the real estate capabilities of the display device 33 (FIG. 1), the display window may be configured with a set of horizontal controls. For example, the “Findings” display window is supplied with a left arrow push-button 642, a right arrow push-button 643, and a left-right scroll slide button 642. The interface illustrated in FIG. 7A further reveals OK, Cancel, and Apply functional push-buttons 530, 532, and 534 respectively. Here, the Apply push-button 534 may be set to an inoperative state.

A preferred reporting profiles configuration manager interface is presented in FIG. 7B. More specifically, FIG. 7B illustrates a schematic diagram of a GUI 705 suited for selecting a study type, a reporting profile, a SRL, a report template, and various other section and label variables used to configure a diagnostic report 800. FIG. 7B generally illustrates an exemplary GUI 705 that may be provided by the configuration manager 175 to guide and control operator access to the various information stored within the various records of the SRL database 325 (FIG. 3) on the data storage device 105 (FIG. 2).

As illustrated, the GUI 705 presents an exemplary interface that may be presented to an operator upon selecting the “Reporting Profiles” interface page. In this regard, the GUI 705 may contain a choose study type data entry field 744, along with an associated pull-down menu selection arrow push-button 745, and a clear push-button 746. Moving to the right across the top portion of the GUI 705, a choose reporting profile data entry field 756 may be provided along with an associated pull-down menu selection arrow push-button 757, a new push-button 758, and a delete function push-button 759. Those familiar with common GUI operation will appreciate the operation of the choose study type and choose reporting profile interface items.

Continuing to the right across the top portion of the GUI 705, a report sections selection display 768 may be provided, along with a label push-button 766 operable to insert a labeled section title within the report 800 as desired. In addition to the exemplary labels presented in the sections selection display 768, the GUI 705 may also include a summary label push-button 770. Returning to the left edge of the GUI 705, a SRL data entry field 748 may be provided. Moving down from the SRL data entry field, the GUI 705 may present a HTML template data entry field 750, a description display 752, and a macro display 754. It will be appreciated that pull-down menu selection buttons may be added in association with one or both of the SRL data entry field 748 and the HTML template data entry field 750. In accordance with the preferred configuration manager 175, each of the section labels and summary labels when activated inserts the associated label in accordance with font and other formatting information as provided in the associated report profile 174 (FIG. 2).

As further illustrated, GUI 705 may present a finding groups display 760 operable to present the titles of the various diagnostic finding groups or sets previously stored within the SRL database 325 (FIG. 3). In accordance with the preferred configuration manager 175, only those diagnostic finding sets that match the presently selected SRL as displayed in the language data entry field 748 will be made available for integration into the report profile 174 (FIG. 2).

As further illustrated in the GUI 705, the finding group display interface 760 may be supplied with an up arrow push-button 761, a down arrow push-button 764, and an up down scroll slide button 762. In addition, the configuration manager 175 may be configured to provide a series of group box data entry fields 772, 774, 776, 778. Each of the group box data entry fields 772, 774, 776, 778 is operable to receive a respective finding group. For example, group box 774 is associated with the Abdominal Situs diagnostic finding group within the SRL database 325 (FIG. 3). In accordance with the preferred configuration manager 175, when the reporting physician enters an input associated with opening group box 774, the finding group display interface 760 is updated to present a list of all finding codes that have been assigned to the Abdominal Situs diagnostic finding group. A reporting physician may then selectively choose those diagnostic findings from the Abdominal Situs group that she desires to include in the diagnostic report 800. The GUI 705 illustrated in FIG. 7B further reveals the previously described OK, Cancel, and Apply functional push-buttons 730, 732, and 734 respectively. Here, all three functional push-buttons 730, 732, and 734 may be set to an operative state.

The configuration manager 175 relies on the linguistic skills of the operator (e.g., a multi-lingual reporting physician) to enter a valid statement with correct punctuation in the secondary reporting language of the presently active diagnostic finding set. For example, if the operator is editing a diagnostic finding associated with a heart study that is to be reported in the French language, the configuration manager 175 relies on the operator to enter a suitable statement in the French language.

It will be appreciated that default diagnostic finding sets may be previously supplied within the SRL database 325 and approved by multi-lingual physicians skilled in each study area. While it is preferred that each diagnostic finding set associated with a particular study type is to be used to generate consistency in diagnostic reporting throughout a medical service site, the configuration manager 175 provides the flexibility to permit each reporting physician to add a personalized set of finding codes. It is significant to note that the text associated with a finding code may not be altered after it is used in a report. The reporting physician may modify finding code identifiers before the finding code is used in a report. The reporting physician may add codes to augment the initial default set. In addition, the reporting physician may remove finding codes from her personal reporting profile.

As a result of this methodology (i.e., separating the configuration manager 175 from the user interface 110), the medical report generator 100 only presents diagnostic findings generated using the SRL selected by the present reporting physician in the medical report generator GUI(s). In preferred implementations the medical report generator 100 enables each reporting physician to select from the complete list of available secondary reporting languages. Furthermore, the medical report generator 100 may be configured to permit each reporting physician access to a default diagnostic finding set with report text in written the PAL.

Medical Report Generator Interfaces

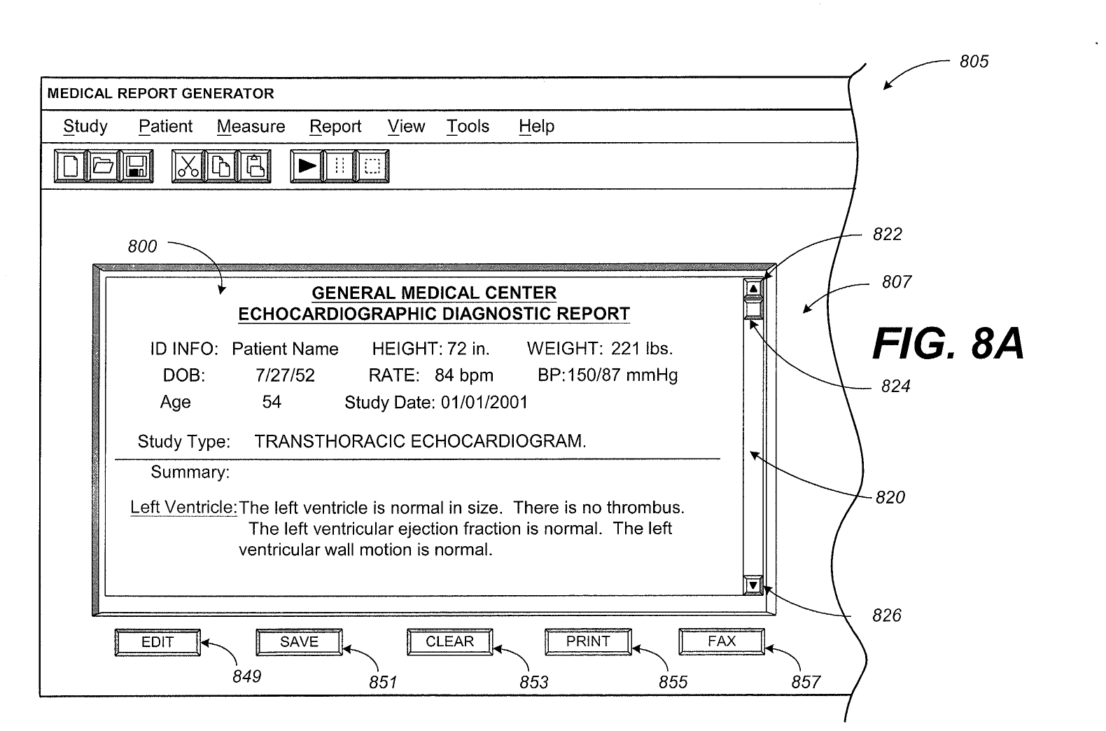

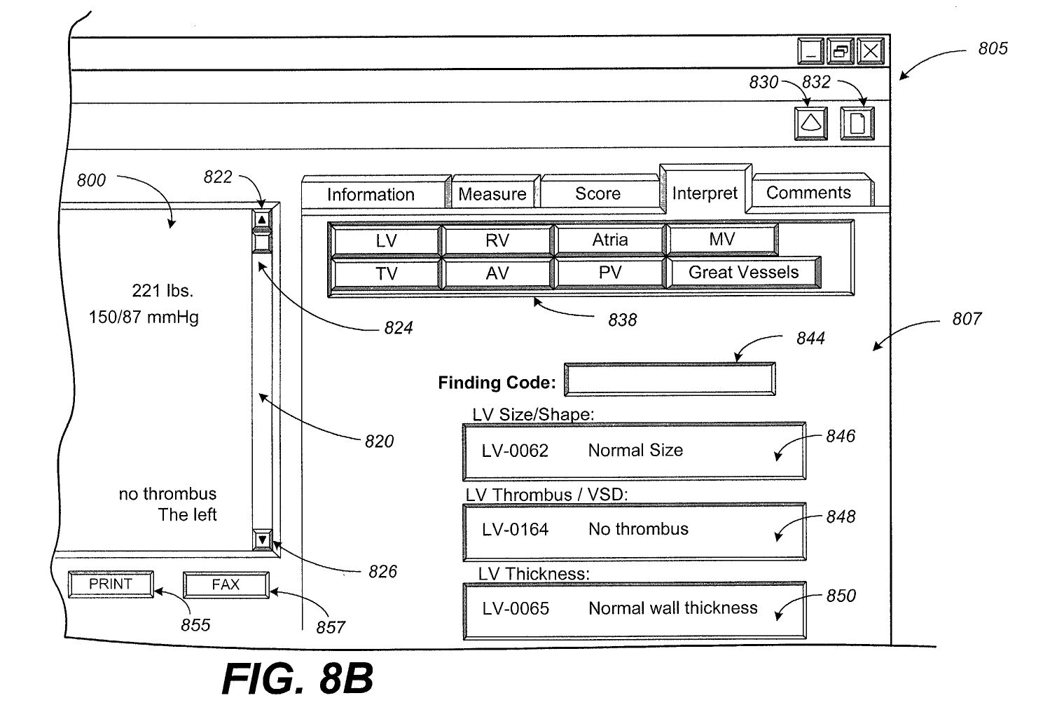

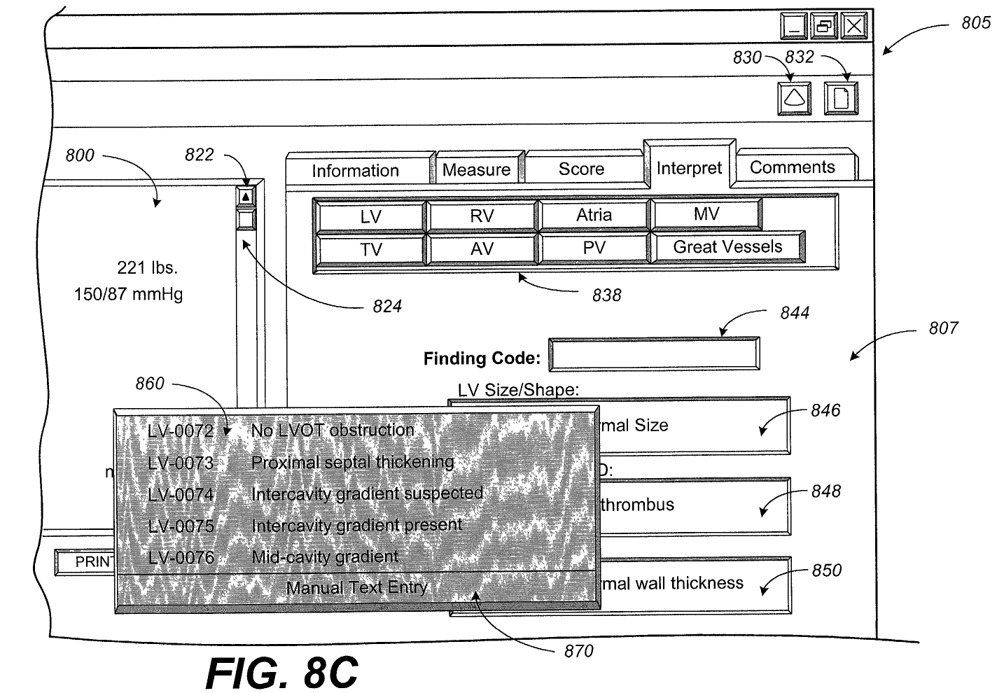

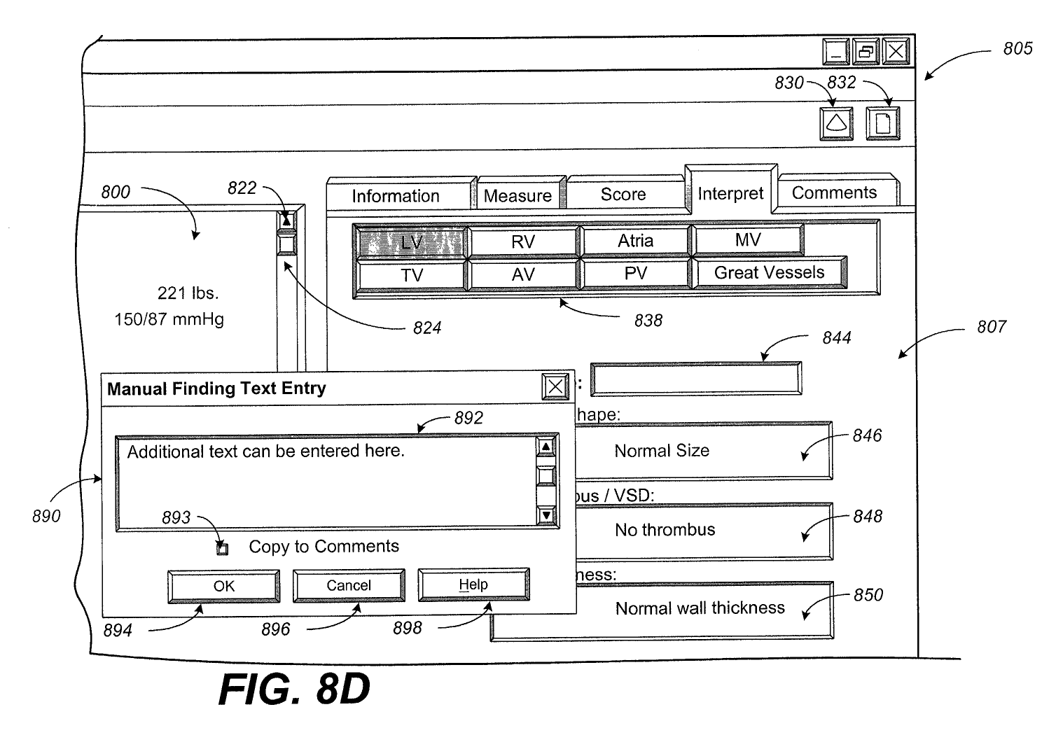

Reference is now directed to FIG. 8A, which illustrates the left most portion of a GUI 805 suited for displaying an exemplary report 800 that may be generated by the medical report generator 100 of FIG. 2. In this regard, an active diagnostic report pop-up 807 may contain a display window, which may contain a real-time display reflecting a what you see is what you get (WYSIWG) display of the diagnostic report 800. As illustrated in FIG. 8A, the display window 807 may contain information identifying the site, the type of report or study, the patient, a summary of the report, as well as, detailed findings. It will be appreciated that the display window 807 (and the underlying report 800) may also contain information identifying the reporting physician and one or more designated parties to receive the report 800 (not shown).

The preferred medical report generator 100 provides a text-editor to enable a reporting physician to add notes or other information to a report 800. In this regard, the medical report generator 100 provides word processing functionality common in popular word processing programs. For example, the GUI 500 enables text selection, cut, paste, real-time spell checking, as well as, other functions as may be provided in association with the pull-down menus and the functional push-button icons in the header of the GUI 500.

FIG. 8B illustrates the right most portion of the GUI 805 suited for creating an exemplary report 800 generated by the medical report generator 100 of FIG. 2. In this regard, the GUI 805 is configured to provide a report source icon labeled push-button 830 and a report mode icon labeled functional push-button 832. In accordance with the preferred medical report generator 100, the functional push-buttons 830, 832 are configured to select a display mode. The left-most icon labeled functional push-button 830 is configured to set the display to present imagery from an image acquisition and storage system 150 (FIG. 1).

It should be appreciated that imagery may be provided by various image acquisition and storage systems 150 including a host of ultrasound and radiological imaging platforms. The right-most labeled functional push-button 832 is configured to return the display 33 to the medical report generator 100.

As further illustrated in FIG. 8B, the GUI 807 may be configured to present a multiple page interface to assist an operator in generating the report 800. As shown in FIG. 8B, the GUI 807 presents an exemplary interface that may be presented to an operator upon selecting the “Interpret” interface page. In this regard, the GUI 807 may contain a finding code group or set label display 838 containing a plurality of labels suited for the present patient study type. For example, the finding code set label display 838 contains a set of push buttons labeled, “ILV,” “RV,” “Atria,” “MV,” “TV,” “AV,” “PV,” and “Great Vessels.” Those skilled in ultrasound studies of the heart will recognize the various labels for various portions of the anatomy of the human heart. As is also shown in FIG. 8B, the GUI 807 may be supplied with a finding code data entry field 844. It will be appreciated that the finding code data entry field 844 may be configured to permit an operator to select a particular diagnostic finding for inclusion in the report 800.

Upon activating one of the push-buttons from the finding code group or set label display 838, those finding codes selected to appear in the report 800 may be listed in the interface as shown. For example, the GUI 807 displays the labels that appear over the display boxes 846, 848 and 850, etc. The GUI 807 also sets a list of values that will appear when you right click in the display boxes 846, 848 and 850 and/or others not shown. Preferably, the display boxes 846, 848, and 850 first appear empty. They are populated only when a user right clicks the box and selects a value from the pop-up menu or when a user enters a finding code directly in the finding code box 844.

For example, when an operator of the GUI 807 activates the LV button in the finding code set label display 838, the display boxes 846, 848, and 850 are labeled with the finding group names that this profile has associated with LV or left ventricle. When an operator of the GUI 807 enters an input indicative of activating a pop-up menu (e.g., depressing a right-mouse pushbutton) with a cursor positioned over the display boxes 846, 848, and 850, the operator is presented a list of available finding code selections from the appropriate left ventricle group.

Similarly, when an operator of the GUI 807 activates the RV button in the finding code set label display 838, the display boxes 846, 848, and 850 are labeled with the finding group names that this profile has associated with RV or right ventricle. When an operator of the GUI 807 enters an input indicative of activating a pop-up menu (e.g., depressing a right-mouse pushbutton) with a cursor positioned over the display boxes 846, 848, and 850, the operator is presented a list of available finding code selections from the appropriate right ventricle group.

It should be appreciated that after traversing the finding groups in the finding code set label display 838 and selecting a plurality of LV finding group diagnostic finding codes, the GUI 807 may present diagnostic finding “LV-0062” in a first diagnostic finding display window 846. As illustrated in FIG. 8B, the display window 846 may be labeled with a short note as to the subject of the finding. Here, display window 846 is labeled, “LV Size/Shape:” or left-ventricle size and shape. The display window 846 may also contain a short title for the diagnostic finding. When the reporting physician enters a command indicative that the physician desires to open the contents associated with the display window 846, all the finding codes included in the finding codes associated with LV size/shape appear in a pop-up that will be further described with regard to FIG. 8C. Here, in FIG. 8B, display window 846 indicates that the reporting physician has determined that the left-ventricle is of normal size. As is also illustrated in FIG. 8B, second and third diagnostic finding display labels 848, 850, respectively, corresponding to findings related to other diagnostic parameters of the left-ventricle appear.

In accordance with the preferred medical report generator 100, upon operator selection of a different finding code group or set push-button from the finding code group label display 838, the various display box labels 846, 848, and 850 will update with information reflective of the selected label. For example, if the operator selects “RV,” the various display windows 846, 848, 850 will be labeled appropriately with diagnostic findings associated with the right-ventricle of the heart.

FIG. 8C highlights an alternative display mode associated with the GUI 807. In response to an operator selection operation (e.g., depressing a right-mouse push-button as the cursor is positioned over the “LV” label in the finding code group label display 838), each of the available diagnostic findings in the presently active reporting language may be displayed in a pop-up display 860. The reporting physician highlights desired finding codes displayed in the pop-up display 860 and enters the highlighted finding code into the diagnostic report 800 by selecting an appropriate input. Also provided in the pop-up display 860 is an operator selectable item 870 labeled, “Manual Text Entry,” that permits an operator to enter a manual text data entry mode. In accordance with a preferred embodiment, the selected finding code appears both on the left side of under the appropriate report heading and on the right side of the GUI 807 in the correct display window 846, 848, 850, when the reporting physician selects the report icon push-button 832 in the header of the window 805. When the reporting physician selects the image icon, the left side of the GUI 807 presents the one or more diagnostic images. The report creation portion of the GUI 807 simultaneously reveals which finding codes have been selected for inclusion in the diagnostic report 800.

Reference is now directed to FIG. 8D, which illustrates the manual text entry mode entered via the display window 807 of FIG. 8C. In this regard, the manual text data entry mode may generate a interface window 890 labeled, “Manual Finding Text Entry.” In accordance with the preferred medical report generator 100, the interface window 890 presents a display interface 892 with associated scroll functionality as described in association with other scrollable displays herein. In addition, the interface window 890 contains an operator selectable checkbox 893, labeled “Copy to Comments,” which is operable to direct text entered in the display interface 892 directly to a comments portion of the report 800. As previously described in association with previous GUIs, the interface window 890 may be supplied with OK, Cancel, and Apply functional push-buttons 894, 896, and 898, respectively. Here, all three functional pushbuttons 894, 896, and 898 may be set to an operative state. It will be appreciated that each of the functional icon labeled push-buttons may be configured to interface with the manual text editor of the interface window 890 to provide a plurality of common word processing functions to the operator of the medical report generator 100.

It should be emphasized that the above-described embodiments of the present invention, particularly, any “preferred” embodiments, are merely possible examples of implementations, merely set forth for a clear understanding of the principles of the medical report generator 100. Many variations and modifications may be made to the above-described embodiment(s) of the medical report generator 100 without departing substantially from the spirit and principles of thereof. All such modifications and variations are intended to be included herein within the scope of this disclosure and protected by the following claims.

What is claimed is:

1. A method for providing an automated report in a computer based system, comprising:
identifying diagnostic findings commonly repeated in reports of a specific type;
translating the identified findings into a reporting language;
inserting the translated findings into a language encoded database; and
using the language encoded database in a physician-directed iterative process to identify diagnostic findings responsive to a plurality of observed images.

2. The method of claim 1, wherein identifying comprises analyzing a plurality of reports generated at a particular site.

3. The method of claim 1, wherein identifying comprises analyzing a plurality of reports generated in response to a particular study.

4. The method of claim 1, wherein translating comprises modifying the text of a diagnostic finding used to generate a report product wherein the report product is in a reporting language different from that used in a computer based interface.

5. The method of claim 1, wherein using comprises verifying that a diagnostic finding is encoded with a language identifier indicative of a match with an operator desired reporting language before adding the diagnostic finding to a report.

6. The method of claim 1, wherein using comprises verifying that a diagnostic finding is encoded with a language identifier indicative of a match with an operator desired reporting language before adding the diagnostic finding to a finding set.

7. The method of claim 1, further comprising:
providing access to a multi-lingual reporting physician to an editor, wherein the physician generates customized diagnostic findings in a desired reporting language.

8. The method of claim 6, wherein using comprises associating the diagnostic finding set with a desired reporting language.

9. The method of claim 7, wherein the customized diagnostic findings derive from a previously approved set of diagnostic findings in the reporting physician's desired reporting language.

10. The method of claim 8, wherein using comprises associating the diagnostic finding set with a desired study.

11. A computer based diagnostic reporting system, comprising:
means for providing a plurality of diagnostic findings in a text form conducive for use in a diagnostic report;
means for translating the plurality of diagnostic findings in a reporting language;
means for supplying the plurality of diagnostic findings in the reporting language; and
means for selectively applying the plurality of diagnostic findings to generate the diagnostic report.

12. The system of claim 11, wherein the providing means comprises storing a plurality of diagnostic findings generated by a supervising physician skilled in the analysis of a study.

13. The system of claim 11, wherein the translating means comprises storing a plurality of diagnostic findings in a reporting language different from the language used in a computer interface.

14. The system of claim 11, wherein the supplying means comprises selectively retrieving the stored plurality of diagnostic findings in the reporting language.

15. The system of claim 11, wherein the applying means comprises a medical report generator configured to format the plurality of diagnostic findings in a pre-determined report format.

16. The system of claim 13, wherein the plurality of diagnostic findings are generated by a multi-lingual physician skilled in the analysis of a study.

17. A software application driven report generation system, comprising:
a user interface operable to receive a report template, a plurality of diagnostic findings, and inputs from an operator, the user interface further programmed to provide an output indicative of a report;
a decision logic engine operable to receive the output from the user interface, and the plurality of diagnostic findings, and to evaluate the inputs from the operator, wherein the decision logic engine provides an output indicative of a formatted version of the desired report; and
a renderer configured to receive the output indicative of the formatted version of the desired report and to generate a signal compatible with the report output device.

18. The system of claim 17, wherein the software application is programmed to store data associated with a particular report and operative to selectively retrieve and regenerate the stored report.

19. The system of claim 17, wherein the software application is configured with logic for verifying that a plurality of diagnostic findings selected for inclusion in a report are reflective of the same reporting language.

20. The system of claim 19, wherein the software application is configured with logic that permits a multi-lingual reporter to edit diagnostic findings in a desired reporting language.
